(19) United States
(12) Patent Application Publication
(10) Pub. No.: US 2025/0269389 A1
(43) Pub. Date: Aug. 28, 2025

(54) POINT OF USE HEATING SHOWERHEAD

(71) Applicant: Kohler Co., Kohler, WI (US)

(72) Inventors: Jason Kwacz, Kohler, WI (US); Robin Whitfield, Cheltenham (GB)

(21) Appl. No.: 19/054,991

(22) Filed: Feb. 17, 2025

Related U.S. Application Data
(60) Provisional application No. 63/558,969, filed on Feb. 28, 2024.

(51) Int. Cl. B05B 1/24; B05B 1/18

(52) U.S. Cl. CPC B05B 1/24; B05B 1/18

(57) ABSTRACT

Provided herein is a point of use heating showerhead. The showerhead may comprise a feed pipe coupled to a water input, a waterway connected at a first end to the feed pipe, and a sprayplate connected to a second end of the waterway. Water may flow into the feed pipe via the water input. Water may flow into the waterway via the feed pipe. Water may be heated via the heating element in the waterway. Heated water may exit the showerhead via the sprayplate.

### CROSS-REFERENCE TO RELATED APPLICATIONS

The present application claims priority to U.S. Provisional Patent Application No. 63/558,969, filed Feb. 28, 2024, entitled, “POINT OF USE HEATING SHOWERHEAD,” the entire contents of which are hereby incorporated by reference.

### BACKGROUND

Consumers may use a faucet (e.g., showerhead) which may be located a distance away from a water heater providing heated water to the faucet. At times, the water may lose heat as it travels from the water heater to the faucet. It may be desirable for point of use heating system to heat the water at or near the location of the faucet.

### BRIEF DESCRIPTION OF DRAWINGS

FIG. 1 is a perspective of an example showerhead.

FIG. 2 is a cross-sectional view of an example showerhead.

FIG. 3 is a perspective view of an example showerhead.

FIG. 4 is a perspective view of an example showerhead.

FIG. 5 is a topside view of an example showerhead.

FIG. 6 is a perspective view of an example heating element.

FIG. 7 is a perspective view of an example outlet.

FIG. 8 is an underside view of an example sprayplate.

FIG. 9 is a cross-sectional view of an example waterway.

FIG. 10 is a side view of an example showerhead.

FIG. 11 is a side view of an example showerhead.

FIG. 12 is a cross-sectional view of an example feed pipe.

FIG. 13 is a cross-sectional view of an example showerhead.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

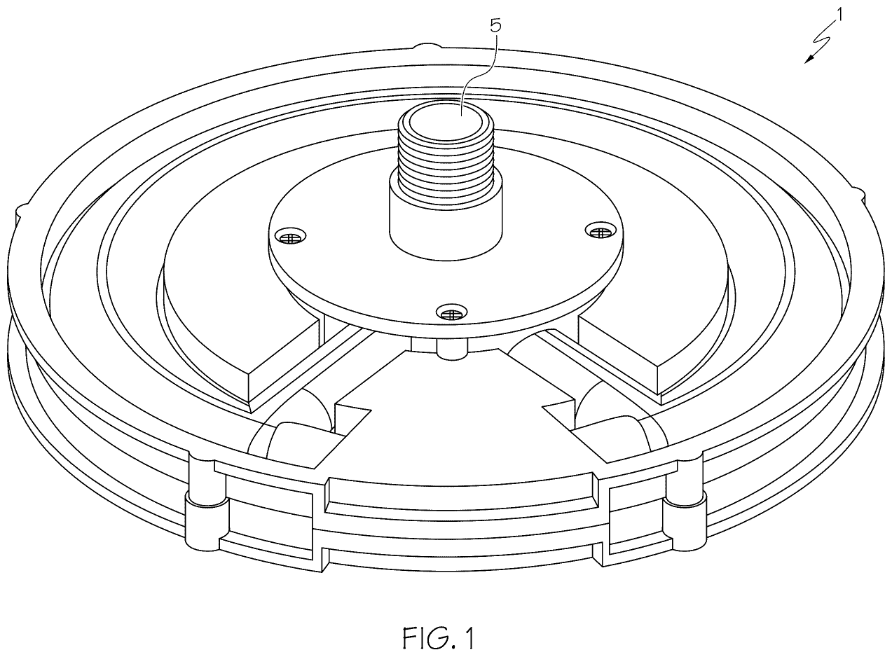

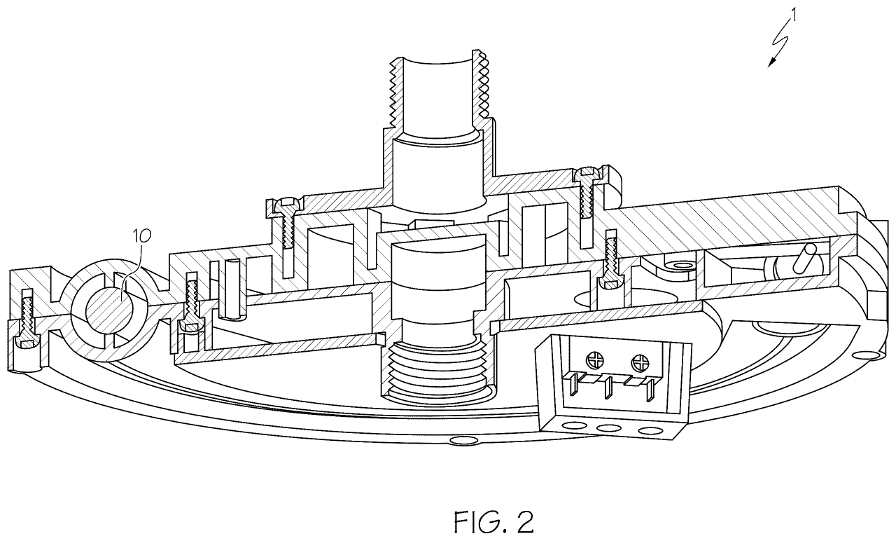

Turning first to FIG. 1, a showerhead 1 may include an inlet 5 for fluid (e.g., water) to enter the showerhead 1. The inlet 5 may attach to a water input (not illustrated). The water input may, for example, be a hot or cold water line. As illustrated in FIG. 2, the showerhead 1 may include a heating element 10 for heating the water entering the showerhead 1. The water passing through the showerhead 1 may directly touch the heating element 10 or may be otherwise heated by the heating element 10.

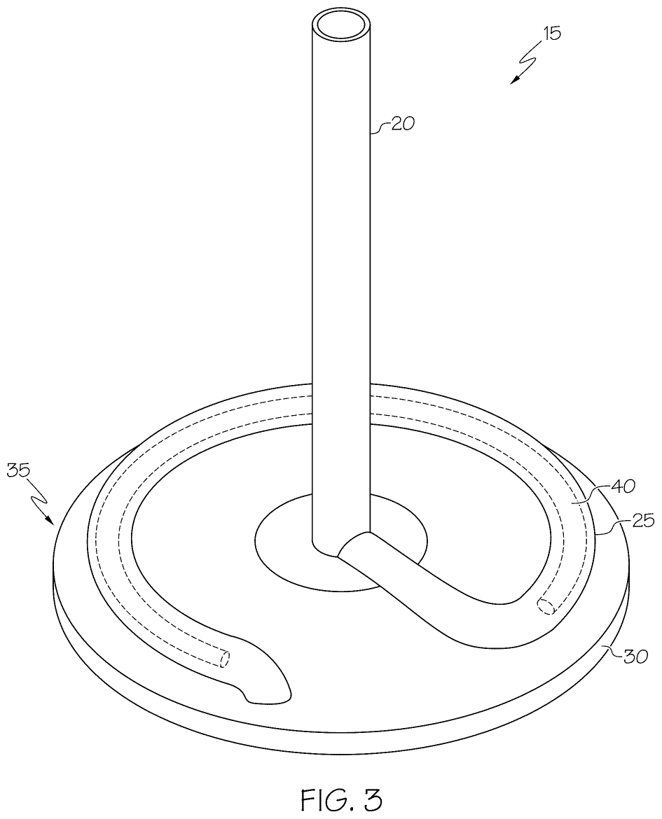

Turning to FIG. 3, a showerhead 15 (which may be similar to showerhead 1 as described above) may include a feed pipe 20 for receiving fluid (e.g., water) from a water input. The feed pipe 20 may be a coaxial pipe within a pipe and may contain a wet chamber to transfer fluid such as water and a dry chamber to contain dry components such as electrical wiring. The feed pipe 20 may be coupled to a waterway 25, which may be a water bore manifold. The waterway 25 may carry water from the feed pipe 20. The waterway 25 may be manufactured as a clam-shell or any other suitable shape (including any other suitable two-part molding). The waterway 25 may be positioned along an outside edge 30 of a sprayplate 35 of the showerhead 15 or may be positioned in any other suitable manner. The waterway 25 may be curved in a similar fashion as the sprayplate 35. A heating element 40 may be contained within the waterway 25 and may heat water passing through the waterway 25. The heating element 40 may be any suitable heating element, including a calrod. The heating element 40 may be any suitable diameter and length; as one example, the heating element 40 may be 6.5 mm in diameter and 300 mm in length. The heating element 40 may be curved in a similar manner as the waterway 25 to fit thereinside or therealong. A suitable radius of the heating element 40 may be selected to allow for the use of wiring and other components in the showerhead 15. A maximum heating energy at a heater surface (i.e., the Watts Density) may be used to determine the length of the heating element 40 at a certain total output. As one example, if the heating element 40 is 6.5 mm in diameter, 3 kW are required from the heating element 40, and the maximum permissible Watts Density is 35 W/mm², then the length of the heating element 40 may be 420 mm. If the heating element 40 has a circular bend (e.g., a 90° bend, as illustrated in FIG. 3), then the bend diameter of the heating element 40 may be 178 mm, which may allow for space at the end of the heating element for other components to attach (as discussed in greater detail below).

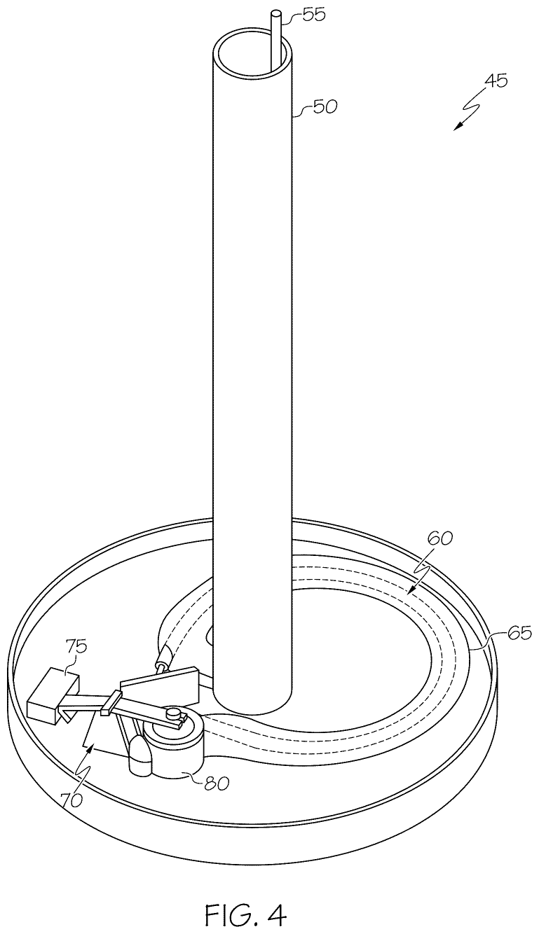

As illustrated in FIG. 4, a showerhead 45 may include a feed pipe 50. The feed pipe 50 may include electrical cable(s) 55 to power a heating element 60 contained within a waterway 65. The showerhead 45 may include any number of electrical cable(s) 55; as one example, the showerhead 45 may include two electrical cable(s) 55. The electrical cable(s) 55 may be any suitable diameter; as one example, the electrical cable(s) 55 may be 6 mm in diameter. The showerhead 45 may include a microswitch actuator 70 or alternative switching system (including a relay and low force/low voltage system) to turn the heating element 60 on or off. The microswitch actuator 70 may include a microswitch 75, which may be wired in series with the heating element 60. The microswitch actuator 70 may be coupled to a pressure switch 80 for determining the pressure within the waterway 65 and surrounding the heating element 60. It may be desirable for the heating element 60 to be fully or substantially submerged in water before the heating element 60 is turned on. When not fully or substantially submerged, the heating element 60 may overheat and may be damaged. A diaphragm valve or any other suitable water detection system may be employed for determining whether the heating element 60 is submerged. In other embodiments, the heating element 60 may be engaged before it is submerged in water.

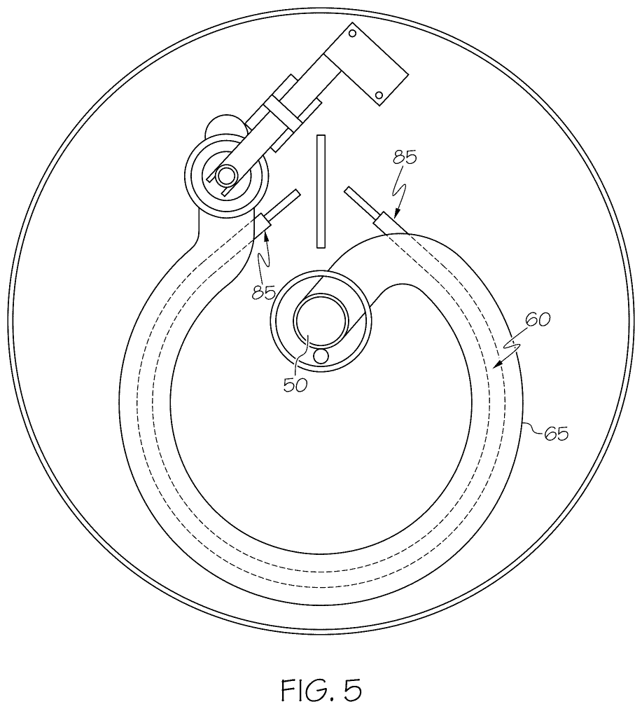

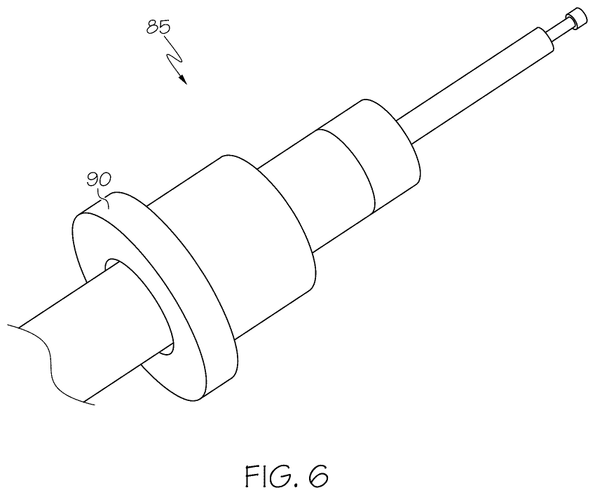

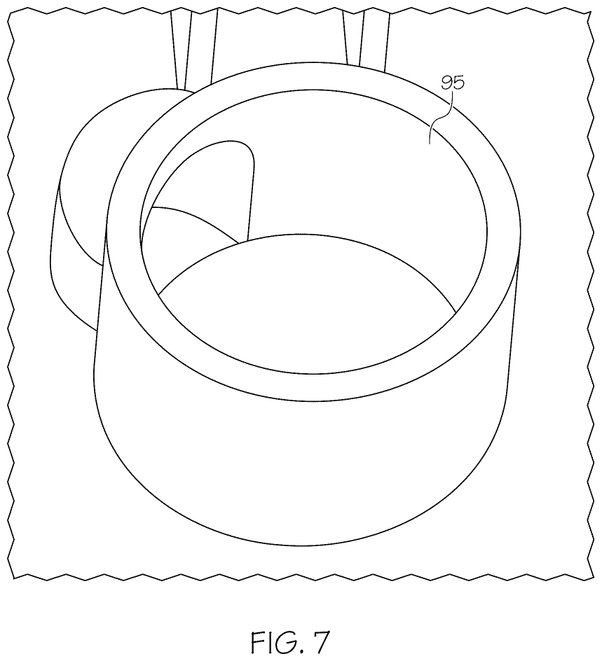

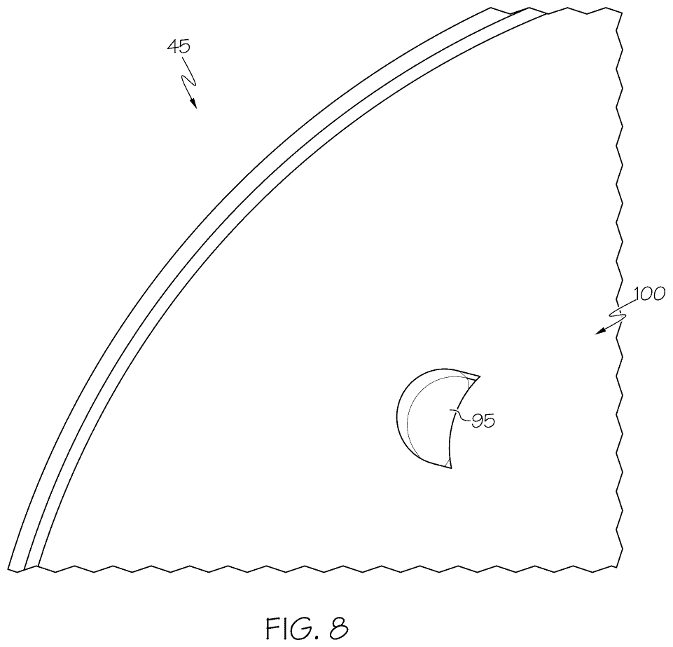

Turning to FIG. 5, water may enter the feed pipe 50 and be fed into and around the waterway 65. The water may pass along the heating element 60 within or along the waterway 65. As illustrated, the heating element 60 may include portions 85 extending out and away from the waterway 65. The portions 85 may be any length; as one example, the portions 85 are 30 mm in length. The length of the portions 85 may be sufficient such that other connectors and components may be attached or connected to the portions 85. The portions 85 may include a soldered “top hat” section 90 (see FIG. 6) to prevent water from leaking out of the waterway 65. The water may exit the waterway 65 via one or more outlets 95, which may be similar to the outlet 95 as illustrated in FIG. 7. Turning to FIG. 8, the outlets 95 may be positioned in any suitable manner on a sprayplate 100 of the showerhead 45. After exiting via the outlets 95, the water may reach a user.

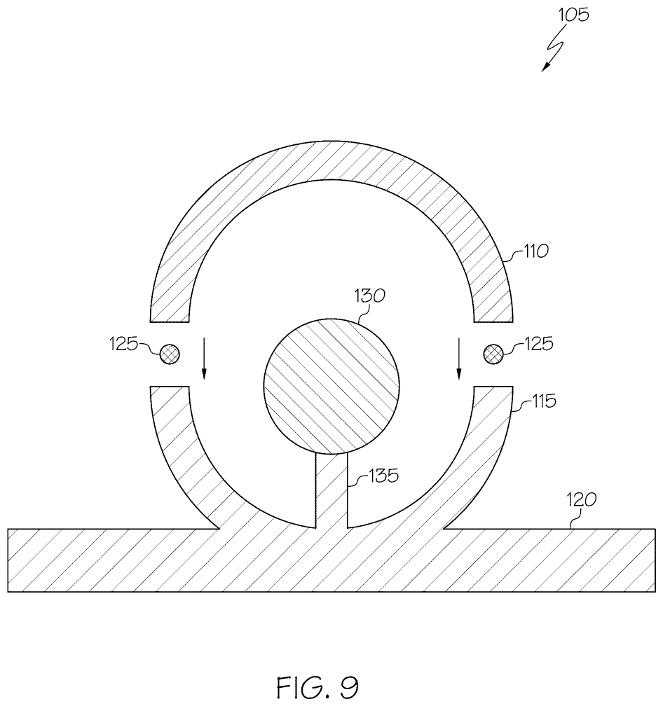

As stated above, the waterway may be manufactured in any suitable manner. As illustrated in FIG. 9, a waterway 105 (which may be similar to waterway 25 or 65) may include an upper half 110 and a lower half 115. The lower half 115 may be coupled or otherwise attached in any suitable manner to a showerhead body 120. The upper half 110 and lower half 115 may be attached to one another via an attachment mechanism 125 (e.g., a seal, glue, ultrasonic weld, or any other suitable attachment mechanism). A heating element 130 (which may be similar to heating element 40 or 60) may be positioned substantially centrally within the waterway 105. The heating element 130 may be supported in the waterway 105 via an element support section 135. The element support section 135 may extend upwardly from the showerhead body 120. The element support section 135 may be heat resistant and may or may not extend the length of the heating element 130.

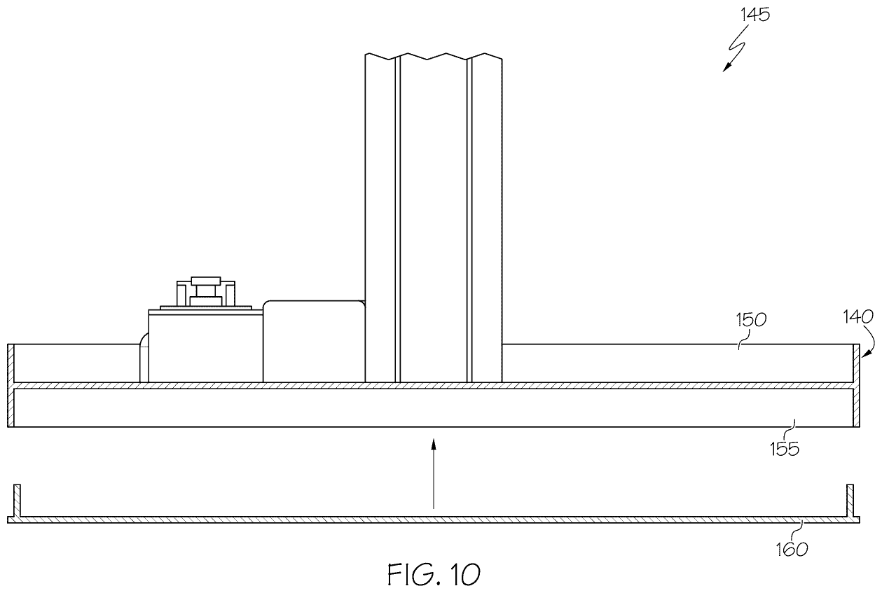

Turning now to FIG. 10, a body 140 of a showerhead 145 (which may be similar to showerhead 1 or 45) may include an upper half 150 and a lower half 155. The upper half 150 and lower half 155 may be separated such that the upper half 150 and associated components are “dry,” while the lower half 155 and associated components are “wet.” The upper half 150 may house the electrical components (e.g., element terminators/connectors, microswitches, etc.). Water may travel down a feed pipe, through the upper half 150, and into the lower half 155. The lower half 155 may direct water out of the showerhead 145 in any suitable manner. The lower half 155 may accept a variety of different sprayplates 160 (each of which may be individually tested for flow and temperature). The connection between the lower half 155 and the associated sprayplate 160 may be waterproof. The body 140 may include a thermistor at an outlet point between the upper half 150 and the lower half 155. The thermistor may be positioned close to nozzles of the sprayplate 160 such that the temperature of water exiting the sprayplate 160 may be measured.

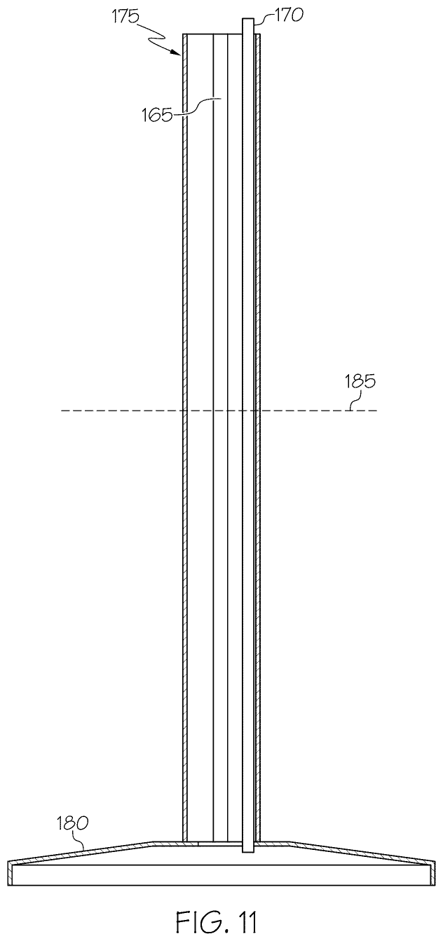

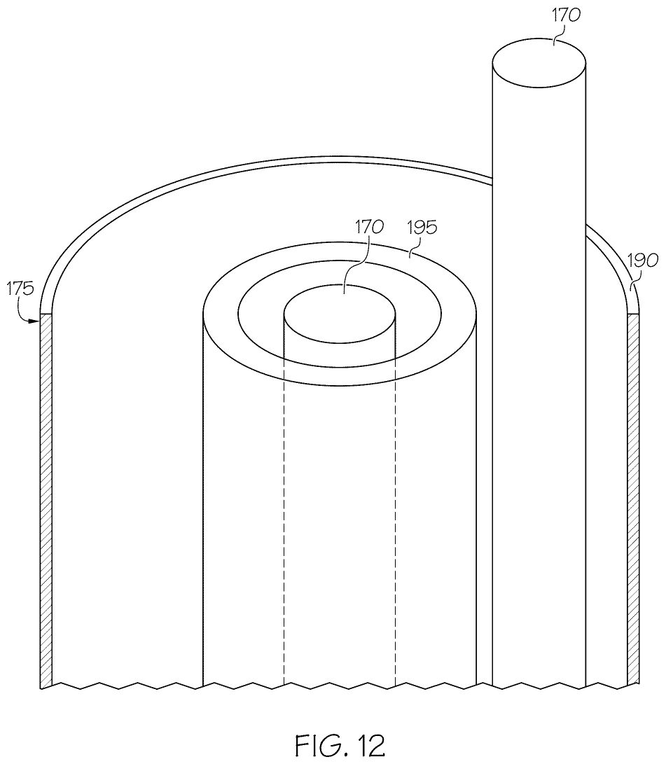

Turning to FIG. 11, a heating element 165 (which may be similar to heating element 40, 60, or 130) and an electrical cable 170 (which may be similar to electrical cable 55) may be placed within a feed pipe 175 (which may be similar to feed pipe 20 or 50) connected to an overhead showerhead 180. The feed pipe 20 may be a coaxial pipe within a pipe and may contain a wet chamber to transfer fluid such as water and a dry chamber to contain dry components such as electrical wiring. The feed pipe 175 may be any suitable length; as one example, the feed pipe 175 has a minimum length of 340 mm and a maximum length of 500 mm. The heating element 165 and electrical cable 170 may extend upward through the feed pipe 175 and may extend past a ceiling height 185 (which may be variable). As illustrated in FIG. 12, the feed pipe 175 may include an outer pipe trim 190. The outer pipe trim 190 may house the electrical cable 170 and a waterway 195 (which may be similar to waterway 25, 65, or 105). The electrical cable 170 may be any suitable diameter; as one example, the electrical cable 170 may be 6 mm in diameter. The waterway 195 may be any suitable diameter; as one example, the waterway 195 is 12 mm in diameter. The waterway 195 may house the heating element 165 in the manner as discussed above. The heating element 165 may be any suitable diameter and length; as one example, the heating element 165 is 6.5 mm in diameter and 380 mm in length. When the heating element 165 is positioned within the feed pipe 175, the heating element 165 may be substantially straight.

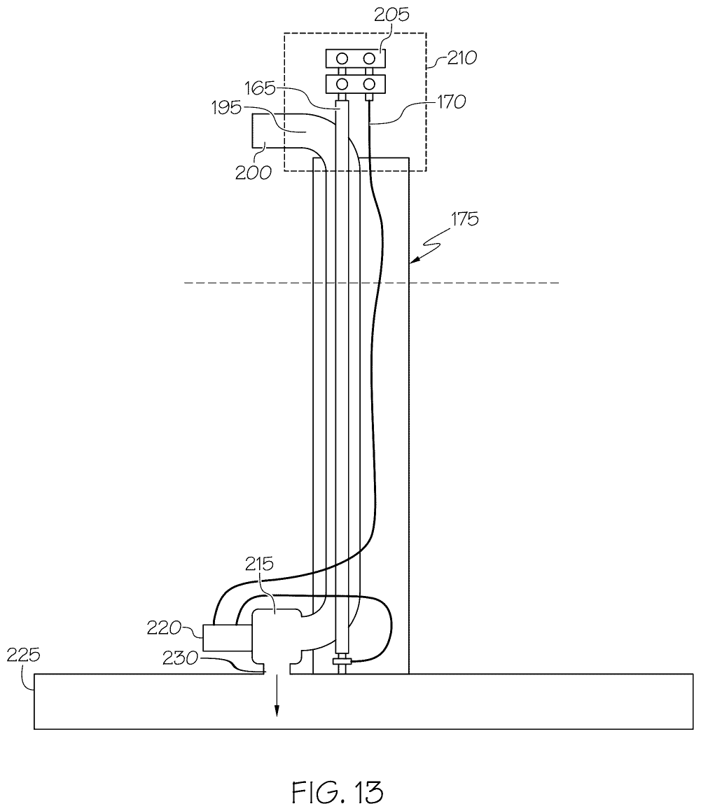

As set forth on FIG. 13, water may enter the waterway 195 housed within the feed pipe 175 via a water inlet 200. Water may flow through the waterway 195 around the heating element 165. The heating element 165 may be connected to a connector block 205, which may be powered by the electrical cable 170. The connector block 205 and the connections between the connector block 205 and each of the heating element 165 and the electrical cable 170 may be housed in an enclosure 210. Water may travel through the waterway 195 and reach a pressure sensor 215 to detect a pressure of the water. Depending on the pressure, a relay, TRIAC, or microswitch 220 may turn on or off. The water may then enter a sprayplate 225 via a waterway outlet 230. The waterway outlet 230 may be any suitable outlet, including a ball joint connector. The water may exit the sprayplate 225 and reach a user.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A showerhead comprising:
a feed pipe coupled to a water input;
a waterway connected at a first end to the feed pipe;
a heating element for heating water from the water input; and
a sprayplate connected to a second end of the waterway;
wherein water flows into the feed pipe via the water input;
wherein water flows into the waterway via the feed pipe;
wherein heated water exits the showerhead via the sprayplate.

2. The showerhead of claim 1, wherein the water input is one of a hot water line or a cold water line.

3. The showerhead of claim 1, wherein water directly touches the heating element.

4. The showerhead of claim 1, wherein the feed pipe is a coaxial pipe including a wet chamber and a dry chamber, wherein the wet chamber and the dry chamber are fluidly separated from one another.

5. The showerhead of claim 4, wherein water flows in the wet chamber, and wherein at least one electrical component for the feed pipe is housed in the dry chamber.

6. The showerhead of claim 1, wherein the waterway is positioned along an outside edge of the sprayplate.

7. The showerhead of claim 1, wherein the heating element has a diameter of 6.5 mm.

8. The showerhead of claim 1, wherein the heating element has a length of 300 mm.

9. A showerhead comprising:
a waterway coupled to a water input;
a heating element at least partially coupled to the waterway; and
a sprayplate connected to the waterway;
wherein water flows into the waterway via the water input;
wherein water is heated via the heating element in the waterway; and
wherein heated water exits the showerhead via the sprayplate.

10. The showerhead of claim 9, wherein the heating element is coupled to a microswitch actuator to activate or deactivate the heating element.

11. The showerhead of claim 10, wherein the microswitch actuator is coupled to a pressure switch for determining a pressure within the waterway and a pressure surrounding the heating element.

12. The showerhead of claim 9, wherein the heating element extends out of a first end of the waterway.

13. The showerhead of claim 9, wherein the heating element is positioned substantially centrally within the waterway.

14. The showerhead of claim 9, wherein water directly touches the heating element.

15. The showerhead of claim 9, further comprising a feed pipe housing at least a portion of the heating element, wherein the feed pipe is a coaxial pipe including a wet chamber and a dry chamber, and wherein the wet chamber and the dry chamber are fluidly separated from one another.

16. The showerhead of claim 15, wherein water flows in the wet chamber, and wherein at least one electrical component for the feed pipe is housed in the dry chamber.

17. A showerhead comprising:
a water input providing water to the showerhead;
a waterway connected at a first end to the water input, wherein water flows into the waterway via the water input; and
a heating element at least partially coupled to the waterway, wherein the heating element heats the water.

18. The showerhead of claim 17, further comprising a sprayplate with one or more nozzles, wherein water exits the showerhead via the one or more nozzles.

19. The showerhead of claim 17, wherein the water directly touches the heating element.

20. The showerhead of claim 17, further comprising a diaphragm valve detecting a level of submergence of the heating element.
